(19) United States
(12) Patent Application Publication
(10) Pub. No.: US 2014/0374655 A1
(43) Pub. Date: Dec. 25, 2014

(54) METHODS FOR MITIGATING THE LEACHING OF HEAVY METALS FROM ACTIVATED CARBON

(71) Applicant: Calgon Carbon Corporation, Pittsburgh, PA (US)

(72) Inventor: Richard A. MIMNA, Oakdale, PA (US)

(21) Appl. No.: 14/308,926

(22) Filed: Jun. 19, 2014

Related U.S. Application Data
(60) Provisional application No. 61/836,945, filed on Jun. 19, 2013.
(60) Provisional application No. 61/839,962, filed on Jun. 27, 2013.

(51) Int. Cl. B01J 20/34; B01J 20/22

(52) U.S. Cl. CPC B01J 20/3416; B01J 20/22
USPC 252/193

(57) ABSTRACT

Compositions, methods, and systems for reducing leaching of heavy metals from sorbents having adsorbed heavy metals are described herein. Such compositions and methods may include reducing agents.

### CROSS-REFERENCE TO RELATED APPLICATIONS

This application claims priority to U.S. Provisional No. 61/836,945 entitled “Methods For Mitigating The Leaching Of Heavy Metals From Activated Carbon” filed Jun. 19, 2013 and U.S. Provisional No. 61/839,962 entitled “Methods For Mitigating The Leaching Of Heavy Metals From Activated Carbon” filed Jun. 27, 2013, the entire contents of which are hereby incorporated by reference.

### GOVERNMENT INTERESTS

Not applicable

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

Not applicable

### SUMMARY OF THE INVENTION

Various embodiments of the invention are directed to methods for reducing heavy metal leaching from sorbents having associated heavy metals. Such methods may include the step of contacting a sorbent having associated heavy metals with a reducing agent. The sorbents having associated heavy metals may be any sorbent including, for example, carbonaceous char, activated carbon, reactivated carbon, carbon black, graphite, natural zeolite, synthetic zeolite, silica, silica gel, alumina clay, diatomaceous earths, and combinations thereof, and the heavy metals may be associated with the sorbent in any way. For example, the heavy metals may be adsorbed to a surface of the sorbent, absorbed by the sorbent, or otherwise attached or electronically bound with the sorbent.

The reducing agent may be any reducing agent such as, for example, ascorbic acid, gallic acid, caffeic acid, ferulic acid, chlorogenic acid, formic acid, oxalic acid, maleic acid, tocopherols, tocotrienols, desferrioxamine, pyruvic acid, including salts of pyruvic acid, cysteine, glutathione, and the like and combinations thereof. In various embodiments, the reducing agent may be about 1 wt. % to about 15 wt. % based on the total weight of the sorbent. In some embodiments, the reducing agent may be ascorbic acid, and in other embodiments, the reducing agent may be monosodium ascorbate, calcium diascorbate, monopotassium ascorbate, magnesium diascorbate, and the like and combinations thereof.

In some embodiments, the sorbent may further include a halogen precursor such as, but not limited to, calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, ammonium chloride, ammonium bromide, ammonium iodide, potassium tri-chloride, potassium tri-bromide, potassium tri-iodide, and combinations thereof. In certain embodiments, the halogen precursor may be impregnated onto the sorbent.

Other embodiments are directed to flue gas adsorbents including a sorbent and a reducing agent such as, for example, ascorbic acid, gallic acid, caffeic acid, ferulic acid, chlorogenic acid, formic acid, oxalic acid, maleic acid, tocopherols, tocotrienols, desferrioxamine, pyruvic acid, including salts of pyruvic acid, cysteine, glutathione, and combinations thereof. The sorbent of such embodiments may be carbonaceous char, activated carbon, reactivated carbon, carbon black, graphite, natural zeolite, synthetic zeolite, silica, silica gel, alumina clay, diatomaceous earths, and combinations thereof.

In some embodiments, the reducing agent may be about 1 wt. % to about 15 wt. % based on the total weight of the sorbent. In certain embodiments, the reducing agent may be ascorbic acid, and in other embodiments, the reducing agent may be monosodium ascorbate, calcium diascorbate, monopotassium ascorbate, magnesium diascorbate, and the like and combinations thereof.

In some embodiments, the adsorbent may be a dry admixture of sorbent and reducing agent, and in other embodiments, the reducing agent may be impregnated onto the sorbent. In certain embodiments, the adsorbent may further include a halogen precursor such as, but not limited to, calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, ammonium chloride, ammonium bromide, ammonium iodide, potassium tri-chloride, potassium tri-bromide, potassium tri-iodide, and the like and combinations thereof. In particular embodiments, the halogen precursor may be calcium bromide (CaBr₂), ammonium bromide (NH₄Br), and combinations thereof. The halogen precursor may be a dry halogen precursor, or in some embodiments, the halogen precursor may be impregnated onto the sorbent.

### DESCRIPTION OF DRAWINGS

For a fuller understanding of the nature and advantages of the present invention, reference should be made to the following detailed description taken in connection with the accompanying drawings, in which:

FIG. 1 shows a flow chart showing elements of an exemplary coal fired power plant.

FIG. 2 shows a chart comparing the percent removal of mercury versus the injection rate for activated carbon.

FIG. 3 shows a bar graph illustrating the reduced leaching of heavy metals using the methods described herein.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention, which will be limited only by the appended claims. Unless defined otherwise, all technical and scientific terms used herein have the same meaning as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must also be noted that as used herein and in the appended claims, the singular forms “a,” “an,” and “the” include plural reference unless the context clearly dictates otherwise. Thus, for example, reference to “a combustion chamber” is a reference to “one or more combustion chambers” and equivalents thereof known to those skilled in the art, and so forth.

As used herein, the term “about” means plus or minus 10% of the numerical value of the number with which it is being used. Therefore, about 50% means in the range of 45%-55%.

As used herein, the term “sorbent material” is meant to encompass all know materials from any source capable of adsorbing mercury. For example, sorbent materials include, but are not limited to, activated carbon, natural and synthetic zeolite, silica, silica gel, alumina, and diatomaceous earths.

The term “heavy metal” will mean toxic metals or metalloids, and in particular, metals and metalloids of environmental and health concern. Examples of heavy metals include, but are not limited to, arsenic, barium, cadmium, chromium, lead, mercury, selenium, and silver.

Mercury is a known environmental hazard and leads to health problems for both humans and non-human animal species. Approximately 50 tons per year are released into the atmosphere in the United States, and a significant fraction of the release comes from emissions from coal burning facilities such as electric utilities. To safeguard the health of the public and to protect the environment, the utility industry is continuing to develop, test, and implement systems to reduce the level of mercury emissions from its plants. In the combustion of carbonaceous materials, it is desirable to have a process wherein mercury and other undesirable compounds are captured and retained after the combustion phase so that they are not released into the atmosphere.

One of the most promising solutions for mercury removal from flue gas is Activated Carbon Injection (ACI). Activated carbon is a highly porous, non-toxic, readily available material that has a high affinity for mercury vapor. This technology is already established for use with municipal incinerators. Although the ACI technology is effective for mercury removal, the short contact time between the activated carbon and the flue gas stream results in an inefficient use of the full adsorption capacity of the activated carbon.

Various embodiments of the invention are directed to methods for removing heavy metals such as, for example, mercury, from a fluid stream produced as a result of combustion of a heavy metal containing fuel source by applying a molecular halogen or halogen precursor to the fuel source or introducing a molecular halogen or halogen precursor into a combustion chamber during combustion of the fuel source or introducing a molecular halogen or halogen precursor into an exhaust stream resulting from the combustion of the fuel source near the combustion chamber and injecting sorbent material into the exhaust stream, i.e. flue gas, resulting from consumption of the fuel source. In such embodiments, the combination of applying the molecular halogen or halogen precursor to the fuel source or injecting the molecular halogen or halogen precursor into the combustion chamber and injection of sorbent material into the exhaust stream may result in substantial reduction in heavy metal emissions from the exhaust stream while significantly reducing the amount of both the molecular halogen or halogen precursor and the sorbent material used in such methods. In particular embodiments, mercury removal is improved over conventional methods. In some embodiments, greater than about 80% or greater than about 90% of the heavy metal can be removed from the exhaust stream based on the heavy metal content of the fuel source. Thus, the combination achieves similar or improved removal rates while reducing consumption of the molecular halogen or halogen precursor and sorbent material thereby reducing costs.

The methods and systems described above may implemented into any conventional system that involves combustion of a fuel source that includes heavy metals. Numerous systems and facilities that burn heavy metal-containing fuels are known and used in the art. For example, some embodiments provide compositions, methods, and systems for reducing emissions of heavy metals from incinerators, including solid waste incinerators. Other embodiments provide compositions, methods, and systems for reducing emissions of heavy metals such as mercury that arise from the combustion of heavy metal containing fossil fuels at, for example, power plants.

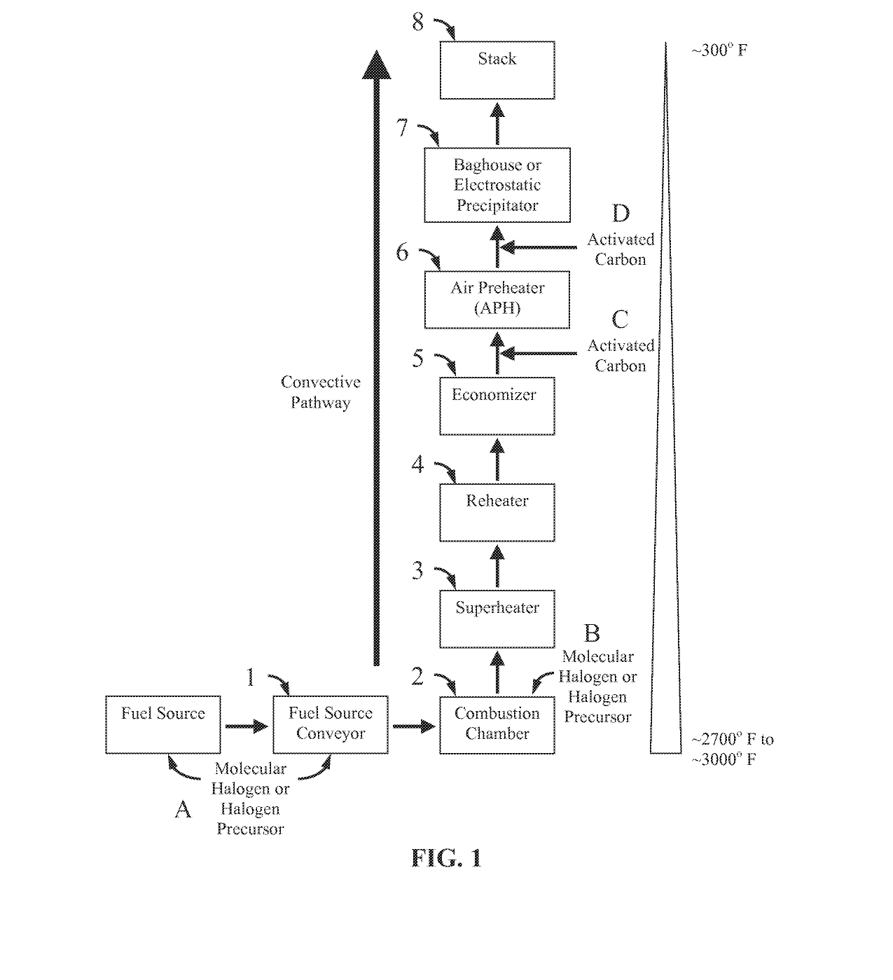

FIG. 1 provides a flow chart depicting relevant portions of an exemplary coal fired power plant. As indicated in FIG. 1, some such facilities may include a feeding mechanism such as a conveyor 1 for delivering fuel such as coal into a furnace or combustion chamber 2 where the fuel source is burned. The fuel fed into the furnace is burned in the presence of oxygen with typical flame temperatures in the combustion chamber of the furnace from about 2700° F. to about 3000° F. as indicated to the right of the flow chart. In operation, the fuel may be fed into the furnace at a rate suitable to achieve the output desired from the furnace the heat from which can be used to boil water for steam or provide direct heat that can be used to turn turbines that are eventually used to produce electricity (not pictured). From the furnace or combustion chamber 2, ash, combustion gases, and air move downstream, away from the fireball, into a convective pathway, or exhaust stream, (large arrow to the left of the diagram) that can include various zones of decreasing temperature as indicated to the right. From the combustion chamber, the heated ash, combustion gases, and air can move through a superheater 3 and, in cases, a reheater 4 where, for example, water is heated to provide steam which will eventually power a turbine that is used to generate electricity. The ash, combustion gases, and air can also pass through, for example, an economizer 5 where water fed into the superheater 3 and/or reheater 4 is preheated, and an air preheater 6 where air that is fed into the combustion chamber 2 is preheated. The combustion gases and ash may eventually pass through a baghouse or electrostatic precipitator 7 where particulate matter is collected. By this time, the temperature of the ash, combustion gases, and air is reduced to about 300° F. before being emitted from the stack 8 and released into the atmosphere.

In some embodiments, the halogen source may be introduced during combustion by injecting molecular halogen or a halogen precursor B into the combustion chamber 2 or by applying the halogen source directly to the fuel source prior to combustion A. In other embodiments, the halogen may be found in the fuel source. For example, waste that includes plastics or rubbers may include halogen containing components that may release halogen ions or molecular halogens during incineration. In various embodiments, sorbent material may be injected into the exhaust stream anywhere along the convection pathway before emission of the ash, combustion gases, and air into the atmosphere, and in particular embodiments, sorbent material may be injected upstream of the baghouse or electrostatic precipitator 7. In certain embodiments, sorbent material may be injected upstream C of the air preheater (APH) 6, and in some embodiments, sorbent material may be injected into the exhaust stream downstream D of the APH 6. In still other embodiments, sorbent material may be injected both upstream C of the APH 6 and downstream D of the APH 6.

The molecular halogen or halogen precursor of various embodiments may be obtained from any source. For example, in some embodiments, molecular sources such as chlorine gas, bromine gas, or iodine gas can be injected into the exhaust stream near the combustion chamber alone or in combination with halogen precursor. In other embodiments, one or more halogen precursors may be applied to the fuel source, introduced into the combustion chamber, injected into the exhaust stream near the combustion chamber, or a combination thereof.

Numerous halogen precursors (halogen precursors) are known in the art and may be used in embodiments of the invention. In some embodiments, the halogen precursor may be a gaseous precursor such as, for example, hydrogen chloride, hydrogen bromide, or molecular chloride or bromide. The halogen precursor may be an organic or inorganic halogen-containing compound. For example, in some embodiments, the halogen precursor may be one or more inorganic halogen salts, which for bromine may include bromides, bromates, and hypobromites, for iodine may include iodides, iodates, and hypoiodites, and for chlorine may be chlorides, chlorates, and hypochloriates. In certain embodiments, the inorganic halogen salt may be an alkali metal or an alkaline earth element containing halogen salt where the inorganic halogen salt is associated with an alkali metal such as lithium, sodium, and potassium or alkaline earth metal such as beryllium, magnesium, and calcium counterion. Non-limiting examples of inorganic halogen salts including alkali metal and alkali earth metal counterions include calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, ammonium chloride, ammonium bromide, ammonium iodide, potassium tri-chloride, potassium tri-bromide, potassium tri-iodide, and the like. In other embodiments, the halogen may from an organic source, which contains a suitably high level of the halogen. Organic halogen precursors include, for example, methylene chloride, methylene bromide, methylene iodide, ethyl chloride, ethyl bromide, ethyl iodide, chloroform, bromoform, iodoform, carbonate tetrachloride, carbonate tetrabromide, carbonate tetraiodide, and the like.

In some embodiments, the halogen precursor may include one or more additional elements such as, for example, a calcium source, a magnesium source, a nitrate source, a nitrite source, or a combination thereof. Exemplary calcium and magnesium sources are well known in the art and may be useful to aid in the removal of sulfur in the flue gas that is released from the fuel source during combustion. In such embodiments, the calcium or magnesium source may include inorganic calcium such as, for example, calcium oxides, calcium hydroxides, calcium carbonate, calcium bicarbonate, calcium sulfate, calcium bisulfate, calcium nitrate, calcium nitrite, calcium acetate, calcium citrate, calcium phosphate, calcium hydrogen phosphate, and calcium minerals such as apatite and the like, or organic calcium compounds such as, for example, calcium salts of carboxylic acids or calcium alkoxylates or inorganic magnesium such as, for example, magnesium oxides, magnesium hydroxides, magnesium carbonate, magnesium bicarbonate, magnesium sulfate, magnesium bisulfate, magnesium nitrate, magnesium nitrite, magnesium acetate, magnesium citrate, magnesium phosphate, magnesium hydrogen phosphate, and magnesium minerals and the like, or organic magnesium compounds such as, for example, magnesium salts of carboxylic acids or magnesium alkoxylates. In certain embodiments, the calcium or magnesium source may be associated with the halide precursor such as, for example, calcium bromide, magnesium bromide, calcium chloride, magnesium chloride, calcium iodide, magnesium iodide, and the like. Nitrate and nitrite sources are also well known in the art and any source of nitrate of nitrite can be formulated with halogen precursor.

The halogen precursor may be a solid such as a powder, a liquid, or a gas. For example, in some embodiments, the halogen precursor may be an aqueous solution that can be sprayed onto the fuel source such as coal before combustion or can be injected into the combustion chamber or exhaust stream near the combustion chamber. A liquid halogen precursor composition may be prepared at any suitable concentration. For example, in some embodiments, an aqueous solution of a halogen precursor such as, for example, calcium bromide or calcium chloride, may have a concentration of up to about 75%, and in other embodiments, the halogen precursor concentration in the aqueous solution may be up to about 60% by weight, 55% by weight, 50% by weight, 45% by weight, or 40% by weight or any concentration between these values. In still other embodiments, an aqueous solution of a halogen precursor may include about 10% to about 75% by weight, about 20% to about 60% by weight, about 30% to about 55% by weight, or about 40% to about 55% by weight of the halogen precursor. Similarly, in other embodiments, dry, powdered halogen precursor may be applied to the coal at a concentration necessary to achieve a similar concentration of halogen in the flue gas stream.

In various embodiments, the molecular halogen or halogen precursor, which may be in solid, such as a powder, liquid, or a gaseous form, may be continuously supplied to the combustion chamber or provided incrementally during combustion. The rate of addition of the molecular halogen and halogen precursor may vary among embodiments and may depend, for example, on the rate of combustion of the fuel source, the origin of the fuel source, the amount of mercury in the fuel source, the adsorption of mercury, and the like. For example, in some embodiments, an about 40% to about 55% by weight aqueous solution of a halogen precursor such as, for example, calcium bromide or calcium chloride, may be introduced into a combustion chamber or injected into an exhaust stream near the combustion chamber at a rate of about 500 gallons/hr or less, and in other embodiments, an about 40% to about 55% by weight aqueous solution of the halogen precursor introduced into a combustion chamber or injected into an exhaust stream near the combustion chamber at a rate of about 400 gallons/hr or less, 300 gallons/hr or less, 200 gallons/hr or less, or 100 gallons/hr or less. In certain embodiments, an about 40% to about 55% by weight aqueous solution of the halogen precursor introduced into a combustion chamber or injected into an exhaust stream near the combustion chamber at a rate of less than 50 gallons/hr or less than 25 gallons/hr or less than 20 gallons/hr.

The feed rate of the molecular halogen or halogen precursor may vary among embodiments and may vary depending on, for example, the feed rate of the fuel source and/or the rate of consumption of the fuel source. For example, a combustion chamber burning about 330 tons/hr of a fuel source such as coal in six mills each burning about 55 tons/hr where about 10 gal/hr of a 50% by weight aqueous solution of calcium bromide (CaBr₂) is introduced into the combustion chamber during burning can result in about 125 ppm bromine added to the coal based on dry weight. Thus, in various embodiments, the concentration and/or feed rate the molecular halogen or halogen precursor may be modified based on the rate of consumption of the fuel source such that up to about 400 ppm (dry basis), up to about 500 ppm (dry basis) or up to about 700 ppm (dry basis) bromine may be added the fuel source. In some embodiments, about 50 ppm to about 500 ppm (dry basis), about 75 ppm to about 400 ppm (dry basis), about 100 ppm to about 300 ppm (dry basis), or about 125 ppm to about 200 ppm (dry basis) of bromine may be added to the fuel source.

In some embodiments, the methods and systems described herein may be utilized in a multi-stage furnace having for example, a primary and secondary combustion chambers, a rotary kiln, afterburning chambers, and any combinations thereof. In such embodiments, molecular halogen or halogen precursor in a solid or liquid form may be introduced into any one or any combination of the chambers of the furnace. For example, in some embodiments, the molecular halogen or halogen precursor may be introduced into one combustion chamber, and in other embodiments, the molecular halogen or halogen precursor may be introduced into a combination of combustion chambers. In still other embodiments, molecular halogen or halogen precursor may be introduced into one or more combustion chambers and into an exhaust stream after combustion.

In certain embodiments, the halogen precursor may be introduced into one or more combustion chambers and/or exhaust stream as an aqueous solution that is sprayed or injected into the chamber or exhaust stream. For example, in some embodiments, an aqueous solution of a halogen precursor may be sprayed or injected into a combustion gas stream downstream of a waste-heat boiler. In still other embodiments, an aqueous solution of the halogen precursor may be introduced into a recirculated substream such as, for example, a recirculated flue gas, recirculated ash, or recirculated fly ash. While embodiments are not limited by the zone where the molecular halogen or halogen precursor is introduced into the exhaust gas stream, the temperature in the injection zone should be sufficiently high to allow dissociation and/or oxidation of the elemental halogen from the halogen precursor. For example, the temperature at the injection zone may be greater than about 1000° F., and in some embodiments, greater than about 1500° F.

Without wishing to be bound by theory, halogens from the molecular halogen or halogen precursor can oxidize with heavy metals released from the fuel source when it is burned in the combustion chamber. In general, oxidized heavy metals, such as mercuric halide species are adsorbable by alkaline solids in the exhaust stream such as fly ash, alkali fused acidic ash (e.g., bituminous ash), dry flue gas desulfurization solids such as calcium oxide, calcium hydroxide or calcium carbonate, and removed from the flue gas by commonly used heavy metal control systems such as, for example, electrostatic precipitators, wet flue gas desulphurization systems, fabric filters, and baghouses. In certain embodiments, oxidized heavy metals may be adsorbed by activated carbon. Without wishing to be bound by theory, the rate at which a solution of a halogen precursor may be significantly reduced by combining the application of a halogen-containing composition with injection of sorbent material into the fluid stream of the combustion gases even when the mercury content of the fuel source is relatively high.

Activated carbon may be used in any embodiment. In such embodiments, the activated carbon may be obtained from any source and can be made from a variety of starting materials. For example, suitable materials for production of activated carbon include, but are not limited to, coals of various ranks such as anthracite, semianthracite, bituminous, subbituminous, brown coals, or lignites; nutshells, such as coconut shell; wood; vegetables such as rice hull or straw; residues or by-products from petroleum processing; and natural or synthetic polymeric materials. The carbonaceous material may be processed into carbon adsorbents by any conventional thermal or chemical method known in the art. The adsorbents will inherently impart different surface areas and pore volumes. Generally, for example, lignites can result in carbon having surface areas about 500-600 m²/g and, typical fiber-based carbons areas are about 1200-1400 m²/g. Certain wood-based carbons may have areas in the range of about 200 m²/g, but tend to have a very large pore volume.

Surface area and pore volume of coal based carbon may also be made to allow for some control of surface area and pore volumes and pore size distributions. In some embodiments, the activated carbon adsorbent may have large surface area as measured by the Brunauer-Emmett-Teller (“BET”) method, and may have a substantial micropore volume. As used herein, “micropore volume” is the total volume of pores having diameter less than about 2 nm. In some embodiments, suitable carbon adsorbents may have a BET surface areas greater than about 10 m²/g or about 50 m²/g, greater than about 200 m²/g, or greater than about 400 m²/g. In other embodiments, the carbon adsorbent may have a micropore volume of greater than about 5 cm³/100 g, and in still other embodiments, the adsorbent may have a micropore volume greater than about 20 cm³/100 g.

Sorbent materials, such as activated carbon, of various sizes have been used to capture heavy metals in systems currently utilized, and any size sorbent material can be used in various embodiments. For example, in some embodiments, the sorbent material may have a mean particle diameter (MPD) of about 0.1 μm to about 100 μm, and in other embodiments, the MPD may be about 1 μm to about 30 μm. In still other embodiments, the MPD of the sorbent material may be less than about 15 μm, and in some particular embodiments, the MPD may be about 2 μm to about 10 μm, about 4 μm to about 8 μm, or about 5 μm or about 6 μm.

In some embodiments, the sorbent material may be treated with, for example, a halogen containing salt. For example, in various embodiments, the sorbent material may be impregnated with a bromine by, for example, immersing the sorbent material in a solution of a hydrogen bromide or a stream of elemental bromine gas for sufficient time to allow the bromine to impregnate the sorbent material. Various methods for impregnating the sorbent material and types of impregnated sorbent material are known and used in the art, and any such sorbent material may be used in embodiments.

The sorbent material may be injected into the exhaust stream anywhere along the convection pathway downstream of the combustion chamber and before the exhaust is emitted from the stack. The sorbent material of various embodiments may generally be injected downstream of a heavy metal control systems such as, for example, electrostatic precipitators, wet flue gas desulphurization systems, fabric filters, and baghouses or other ash or fly ash collection means where particulate matter can be collected and upstream of the combustion chamber. In certain embodiments, the sorbent material may be injected at any zone in the convection pathway having a temperature of less than about 700° F., less than about 500° F., less than about 400° F. or less than about 350° F. For example, in some embodiments, sorbent material may be injected into an exhaust stream either upstream or downstream of an air pre-heater (APH), and in other embodiments, the sorbent material may be injected upstream of an air pre-heater (APH).

In some embodiments, the rate of injection of the sorbent material may depend upon the flow rate of the exhaust stream. For example, in a plant having an exhaust (flue) gas flow rate of about 2,000,000 actual cubic feet per minute (acfm) in which about 100 lbs/hr of sorbent material is injected into the exhaust stream in the ductwork of the plant, the rate of addition of sorbent material is about 0.8 pounds per million actual cubic feet (lbs/MMacf). Therefore, in various embodiments, the injection rate of the sorbent material may vary depending up on the flow rate of the exhaust gas in the ductwork. In such embodiments, the rate of addition of sorbent material based on the flow rate of the exhaust gas may be up to about 4 lbs/MMacf or up to about 5 lbs/MMacf. In other embodiments, the rate of addition of the sorbent material based on the flow rate of the exhaust gas may be from about 0.25 lbs/MMacf to about 5 lbs/MMacf, about 0.5 lbs/MMacf to about 4.0 lbs/MMacf, or about 0.75 lbs/MMacf to about 3.0 lbs/MMacf, and in particular embodiments, the rate of addition may be about 0.75 lbs/MMacf to about 1.5 lbs/MMacf.

Particular embodiments, for exemplary purposes, include methods and systems including the introduction of a halogen precursor, such as, calcium bromide, calcium chloride, sodium bromide, or sodium chloride, into a combustion chamber where a heavy metal containing fuel source is being burned, and injection of sorbent material having an MPD of less than about 15 μm into an exhaust stream upstream of a heavy metal and/or particulate control systems such as, for example, electrostatic precipitators, wet flue gas desulphurization systems, fabric filters, and baghouses or other ash or fly ash collection means where particulate matter can be collected. In some such embodiments, less than about 10 gallons/hour of the an aqueous halogen precursor may be introduced into the combustion chamber, and less than about 100 lbs/hour of sorbent material may be injected into the exhaust stream. As a result of such treatment, mercury emission from the plant employing such methods and systems may be reduced by greater than about 80% and in some embodiments, greater than 90%.

Further embodiments, include methods for reducing mercury emissions from flue gas in which the ratio of halogen to sorbent material provided is from about 0.7 to about 4.6 moles of halogen per pound of activated carbon, and in some embodiments, from about 0.8 to about 3.1 or about 1.2 to about 2.0 moles of halogen per pound of activated carbon. In such embodiments, the sorbent material may have an MPD of less than about 15 μm and, in certain embodiments, the sorbent material may have an MPD of less than about 10 μm. In still other embodiments, the sorbent material may have an MPD of about 6 μm or less. The halogen and sorbent material may be provided anywhere during the process. For example, in some embodiments, the halogen may be applied to the fuel source before combustion, and in other embodiments, the halogen may be introduced into the combustion chamber while the fuel is burned. In still other embodiments, the halogen may be introduced into the flue gas stream either before or after the sorbent material. In further embodiments, the halogen may be provided with the activated carbon. For example, in some embodiments, the halogen may be injected into the flue gas stream separately with the activated carbon, and in other embodiments, the halogen may be applied to the sorbent material before it is introduced into the flue gas stream.

In embodiments in which the halogen is applied to the sorbent material before being injected into the flue gas stream, the ratio of halogen to sorbent material may be the same as the ratio of halogen to sorbent material when sorbent material is introduced separately. For example, in some exemplary embodiments, a halogen salt such as any of the halogen salts described above may be applied to an adsorbent material having an MPD of less than 15 μm, less than 12 μm, less than 10 μm in a ratio of from about 0.14 to about 1.0 pounds of halogen salt per pound of sorbent material to provide a composition that is from about 12 wt. % to about 50 wt. % halogen salt or about 15 wt. % to about 40 wt. % halogen salt. In another exemplary embodiment, a halogen salt such as calcium bromide (CaBr₂) or ammonium bromide (NH₄Br) may be applied to sorbent material having an MPD of about 6 μm at a ratio of about 0.43 pounds of halogen salt per pound of sorbent material or about 30 wt. % halogen salt, and the sorbent material/halogen salt combination may be introduced into the flue gas stream. These ratios can also be expressed as moles of halogen per pound of adsorbent material. For example, in some embodiments, the ratio of moles of halogen per pound of sorbent material may be from about 0.7 moles/lb to about 5.7 moles/lb, 0.8 moles/lb to about 3.1 moles/pound or any ratio there between, and in particular embodiments, the ratio of halogen per pound of sorbent material can be 2.0 moles/lb. In such embodiments, the halogen salt may be applied by conventional impregnation process or the halogen salt may be applied by mixing dry sorbent material with dry halogen salt. In other embodiments, the sorbent material can be impregnated using a gaseous halogen. In certain embodiments, such as those described above, the sorbent material may be activated carbon.

Coal fired power plants utilizing conventional methods for reducing mercury emissions where a halogen precursor is introduced into a combustion chamber and no sorbent material is injected into the exhaust generally inject halogen precursor at a rate of greater than 20 gallons/hour to reduce the mercury emission sufficiently. Coal fired power plants that utilize sorbent material injection without introducing a halogen precursor during combustion can inject greater than about 250 lbs/hour of sorbent material into the exhaust stream to effectively reduce mercury emissions. In contrast, some embodiments of the invention provide mercury reduction of greater than about 80% or greater than 90% while using less than about 10 gallons/hour of a halogen precursor and less than 100 lbs/hour of an activated carbon, and in particular embodiments, less than 100 lbs/hour of sorbent material having a MPD of less than about 15 μm. This is a dramatic and surprising reduction in the amount of consumables necessary to effectively reduce mercury emissions to below regulatory levels. Such embodiments, therefore, provide substantial economic advantages over currently used methods for reducing mercury emission, while simultaneously reducing the amount of ash produced by plants that employ sorbent material injection and the amount of halogen precursor consumed.

In some embodiments, mercury levels can be monitored with conventional analytical equipment using industry standard detection and determination methods, and in such embodiments, monitoring can be conducted periodically, either manually or automatically. For example, mercury emissions can be monitored once an hour to ensure compliance with government regulations and to adjust the rate of halogen precursor introduction into the combustion chamber, the rate of sorbent material injection, or both. Mercury can be monitored in the convective stream at suitable locations. For example, in some embodiments, mercury released into the atmosphere can be monitored and measured on the clean side of a particulate control system.

In some embodiments, the sorbent material may include a reducing agent to mitigate the leaching of heavy metals captured by the sorbent materials. The reducing agent may be included in the composition injected into the flue gas stream or combined with the sorbent material after collection. The “reducing agent” can be any compound or chemical species known in the art that is capable of reducing, i.e., donating an electron, to another compound or chemical species. In some embodiments, the reducing agent is an organic antioxidant, and such compounds may include, and are not limited to, ascorbic acid, gallic acid, caffeic acid, ferulic acid, chlorogenic acid, formic acid, oxalic acid, maleic acids and the like, tocopherols, tocotrienols, desferrioxamine, pyruvic acid, including salts of pyruvic acid, cysteine, glutathione, and the like and combinations thereof. In certain embodiments, the reducing agent may be ascorbic acid including both dextrorotatory and the levorotatory enantiomers of ascorbic acid as well as the mineral ascorbates, such as, but not limited to, monosodium ascorbate, calcium diascorbate, monopotassium ascorbate, magnesium diascorbate, and related compounds.

Without wishing to be bound by theory, reducing agent may mitigate leaching of heavy metals that have been adsorbed by the sorbent material. The reducing agent may reduce the adsorbed mercury halides from a +2 oxidation state, which is soluble, to an insoluble +1 oxidation state. The standard reduction potential)(E⁰) of ascorbic acid at a pH of about 7 and a temperature of about 25° C. is about 0.06 volts. Ascorbic acid may effect this reaction within about 30 minutes in a pH range of about 2 to about 8, and within about 10 minutes in a pH range of about 3 to about 6.

The amount of reducing agent used may vary among embodiments and may be from about 1 wt. % to about 15 wt. %. In some embodiments, the amount of reducing agent added may be about 1 wt. % to 5 wt. %. In other embodiments, the amount of reducing agent added may be about 5 wt. % to about 10 wt. %. In yet other embodiments, the amount of reducing agent added may be about 10 wt. % to about 15% wt. %.

In some embodiments, the reducing agent may be injected into a vessel containing the sorbent material. In some embodiments, injection occurs downstream of the adsorption of the heavy metals. In other embodiments, injection occurs upstream of the adsorption of the heavy metals. In yet other embodiments, injection occurs simultaneously with the adsorption of the heavy metals. In still further embodiments, the ascorbic acid or related compound may be mixed with the activated carbon after the sorbent has been removed from the convective stream.

### EXAMPLES

Although the present invention has been described in considerable detail with reference to certain preferred embodiments thereof, other versions are possible. Therefore the spirit and scope of the appended claims should not be limited to the description and the preferred versions contained within this specification. Various aspects of the present invention will be illustrated with reference to the following non-limiting examples.

### Example 1

A coal-fired power plant fitted with a system to add calcium bromide onto the coal prior to the combustion chamber and lances for injecting activated carbon into the ductwork of the power plant at various locations was utilized for testing. Coal burned at this facility was periodically tested for mercury content to ensure accuracy of mercury removal testing. Various powdered activated carbons (PACs) tested at this facility are provided in Table 1.

TABLE 1
Powdered Activated Carbon (PAC)

| | Particle Size | |
|---|---|---|
| Identifier | (MPD) | Brominated |
| Std | 16 μm | No |
| Std Br | 16 μm | Yes |
| PAC 6 | 6 μm | No |
| PAC 30 | 30 μm | No |

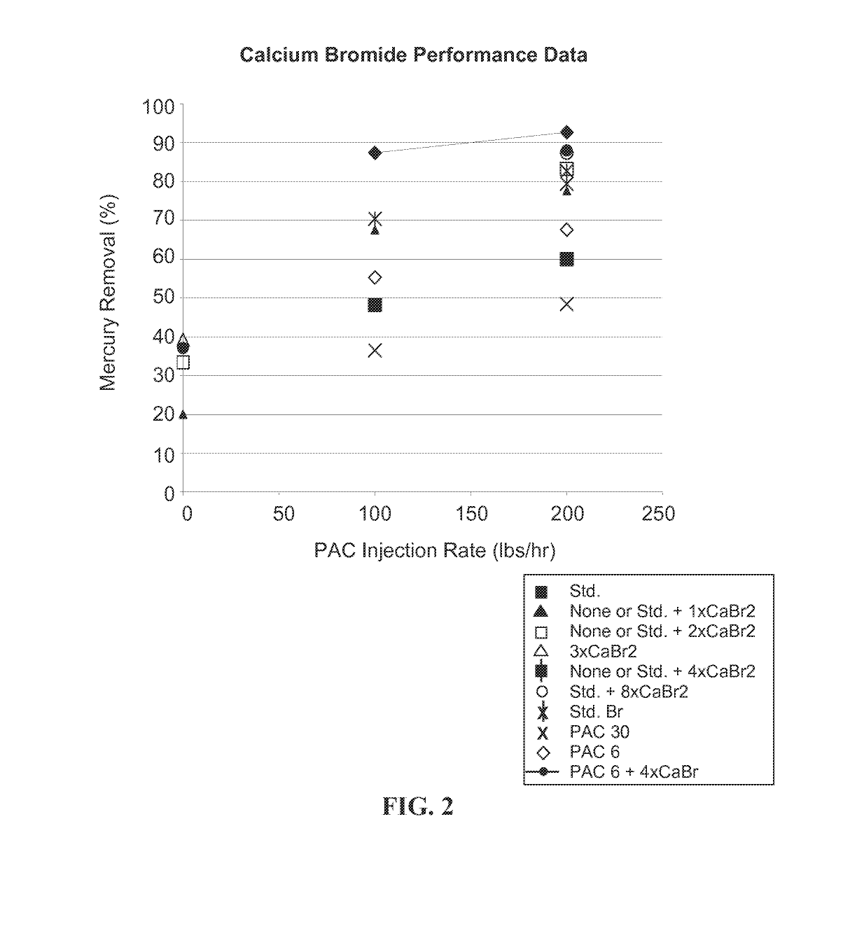

Each of the PACs described in Table 1 was injected into the exhaust stream of the plant downstream of the APH at rate of about 100 lbs/hr or about 200 lbs/hr either with or without calcium bromide (CaBr₂) injection into the combustion chamber. The results are provided in Table 2 and are illustrated in FIG. 2.

TABLE 2
Injection Rate Raw Data

| Symbol | | | PAC Injection | Removal |
|---|---|---|---|---|
| FIG. 2 | Particle | CaBr | Rate (lbs/hr) | (%) |
| ▪ | Std. | 0 | 100 | 48.2 |
| | Std. | 0 | 200 | 60.0 |
| ▴ | None | 1X | 0 | 20.0 |
| | Std. | 1X | 100 | 67.5 |
| | Std. | 1X | 200 | 77.6 |
| □ | None | 2X | 0 | 33.4 |
| | Std. | 2X | 200 | 83.3 |
| Δ | None | 3X | 0 | 39.2 |
| | None | 4X | 0 | 37.1 |
| | Std. | 4X | 200 | 88.0 |
| ◯ | Std. | 8X | 200 | 87.4 |
| * | Std. Br | 0 | 100 | 70.4 |
| | Std. Br | 0 | 200 | 82.7 |
| | Std. Br | 0 | 200 | 79.4 |
| X | PAC 30 | 0 | 100 | 36.5 |
| | PAC 30 | 0 | 200 | 48.4 |
| ⋄ | PAC 6 | 0 | 100 | 55.3 |
| | PAC 6 | 0 | 200 | 67.6 |
| ♦ | PAC 6 | 4X | 100 | 87.4 |
| | PAC 6 | 4X | 200 | 92.7 |

As indicated in FIG. 1, CaBr₂ alone, PAC injection rate 0, resulted in less than about 50% mercury removal based on the mercury content of the coal consumed. The addition of PAC at 100 lbs/hr (PAC 30, PAC 16, PAC 6) resulted in similar reduction in mercury emission, about 50%, which varied slightly depending on the MPD of the PAC. The combination of CaBr₂ injection into the combustion chamber and PAC injection in the exhaust stream (Std+1×CaBr₂) showed improved reduction in mercury emission, as did the injection of brominated PAC (Std Br) into the exhaust stream. Notably, the combination of CaBr₂ injection into the combustion chamber and injection of a PAC having a smaller MPD into the exhaust stream (PAC 6+4×CaBr₂) resulted in nearly 90% reduction in mercury emissions, which represents almost 20% greater reduction in mercury emissions over brominated PAC (Std Br) and larger MPD PAC and CaBr₂ (Std.+1×CaBr₂). Similarly, when the injection rate for PAC was increased to 200 lbs/hr, small MPD PAC outperformed brominated PAC (Std. Br) and larger MPD PAC and various injection rates of CaBr₂ (Std. 1×CaBr₂; Std. 2×CaBr₂; Std. 3×CaBr₂; Std. 4×CaBr₂; and Std. 8×CaBr₂).

### Example 2

Further testing was carried out to determine the injection rate for a given aqueous solution of CaBr₂ and PAC when the PAC is injected into the exhaust stream upstream of the APH (Post APH Injection) and downstream of the APH (Pre APH Injection) required to obtain 90% removal of mercury from plant emissions. The results are provided in Tables 3 and 4, respectively.

TABLE 3
Consumption at 90% mercury removal
POST APH INJECTION

| Identifier | CaBr₂ (gal/hr) | PAC (lbs/hr) | #/MMacf |
|---|---|---|---|
| Std. | 20 | 300 | 2.5 |
| PAC 6 | 20 | 150 | 1.2 |
| Std. Br | | 420 | 3.4 |

TABLE 4
Consumption at 90% mercury removal
PRE APH INJECTION

| Identifier | CaBr₂ (gal/hr) | PAC (lbs/hr) | #/MMacf |
|---|---|---|---|
| Std. | 18 | 125 | 1.0 |
| PAC 6 | 6 | 60 | 0.5 |
| Std. Br | | 320 | 2.6 |

Tables 3 and 4 show that a rate of CaBr₂ injection of 20 gal/hr and a PAC injection rate of 150 lbs/hr is sufficient to remove 90% of the mercury from the coal tested when small MPD PAC (PAC 6) is injected downstream of the APH whereas twice as much large MPD PAC (Std.) is required to achieve a similar result. When the PAC is injected upstream of the APH, 6 gal/hr of CaBr₂ and 60 lbs per hour of small MPD PAC (PAC 6) is necessary to remove 90% of the flue gas mercury at the same plant whereas 18 gal/hr of CaBr₂ and 125 lbs/hr of standard MPD PAC (Std.) are required to achieve the same result. These data demonstrate that a decrease in carbon particle size, especially below about 12 μm or about 10 μm, creates its own synergistic effect in that, surprisingly, both less carbon and less halogen are needed for the same level of mercury removal, especially at levels around or above 90% mercury removal. The combined savings in both halogen and sorbent result in greatly improved economics as well as fewer balance-of-plant impacts such as reduced carbon in the fly ash, allowing more of the ash to retain commercial value as a concrete additive.

### Example 3

Various materials were added to two samples of spent activated carbon that had adsorbed about 12 mg Hg/g carbon and were tested to see if the added materials altered the amount of mercury that was leached during a Toxicity Characteristic Leaching Profile Test (“TCLP Test.”). As received for testing, the samples of spent sorbent typically range from a TCLP value of about 0.4 mg Hg/L to about 0.06 mg Hg/L. A spent sorbent is considered to pass the TCLP test if the leached mercury and/or mercury compounds is below a threshold of 0.2 mg Hg/L.

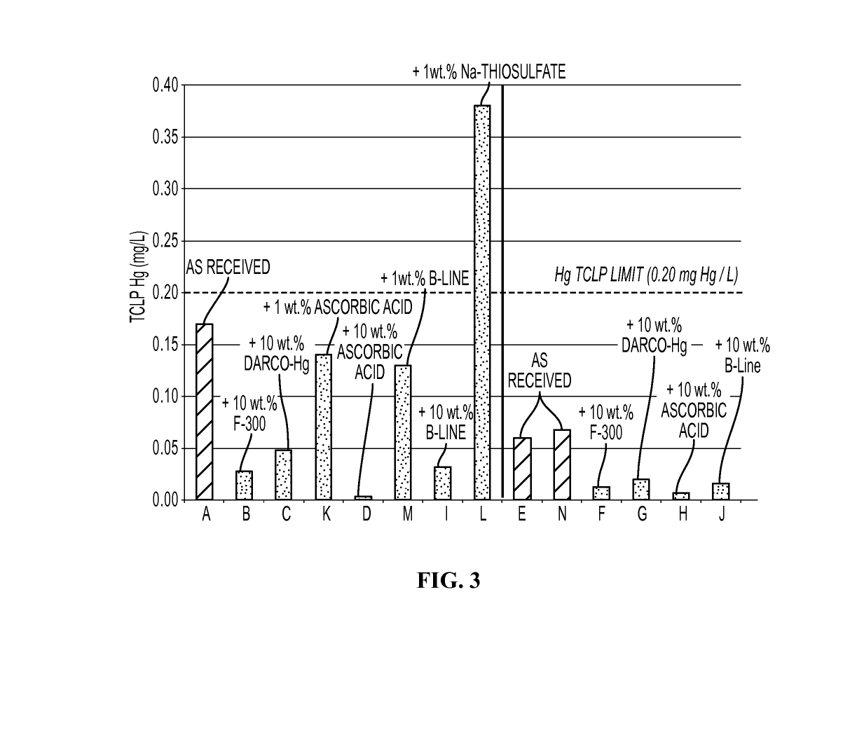

FIG. 3 is a bar graph showing TCLP scores for various spent sorbents (columns a, e, and n). The addition of the addition of 10 wt. % virgin activated carbon, F-300 from Calgon Carbon (b, f), Darco-Hg (c, g), and bituminous PAC (i, j) was effective at lowering the mercury TCLP values (mg/L). FIG. 3 also shows the effects of combining a reducing agent with the spent sorbent. In particular, ascorbic acid (d, h) reduced leaching more effectively than any of the virgin sorbents. These data also show that the use of ascorbic acid at an amount of about 1 wt. % (k) and about 10 wt. % (d, h) were effective in keeping the sorbent below the TCLP threshold of 0.2 mg Hg/L. In contrast, the use of sodium thiosulfate (l), a known reducing agent, was found to exacerbate the leaching of the mercury, bringing the levels of mercury leached to almost double the TCLP threshold of 0.2 mg Hg/L.

### Example 4

Chromium (VI) leaching was tested on a sample having a TCLP score as received of 0.033 mg/L. The addition of 10 wt. % ascorbic acid mitigated Chromium (VI) leaching to undetectable levels.

1. A method for reducing heavy metal leaching comprising contacting a sorbent having associated heavy metals with a reducing agent.

2. The method of claim 1, wherein the sorbent is selected from the group consisting of carbonaceous char, activated carbon, reactivated carbon, carbon black, graphite, natural zeolite, synthetic zeolite, silica, silica gel, alumina clay, diatomaceous earths, and combinations thereof.

3. The method of claim 1, wherein reducing agent comprises about 1 wt. % to about 15 wt. % based on the total weight of the sorbent.

4. The method of claim 1, wherein the reducing agent is ascorbic acid.

5. The method of claim 1, wherein the reducing agent is selected from the group consisting of monosodium ascorbate, calcium diascorbate, monopotassium ascorbate, magnesium diascorbate, and combinations thereof.

6. The method of claim 1, wherein the sorbent further comprises a halogen precursor.

7. The method of claim 6, wherein the halogen precursor is selected from the group consisting of the calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, ammonium chloride, ammonium bromide, ammonium iodide, potassium tri-chloride, potassium tri-bromide, potassium tri-iodide, and combinations thereof.

8. The method of claim 6, wherein the halogen precursor is impregnated onto the sorbent.

9. A flue gas adsorbent comprising:
a sorbent; and
a reducing agent selected from the group consisting of ascorbic acid, gallic acid, caffeic acid, ferulic acid, chlorogenic acid, formic acid, oxalic acid, maleic acid, tocopherols, tocotrienols, desferrioxamine, pyruvic acid, including salts of pyruvic acid, cysteine, glutathione, and combinations thereof.

10. The flue gas adsorbent of claim 9, wherein the sorbent is selected from the group consisting of carbonaceous char, activated carbon, reactivated carbon, carbon black, graphite, natural zeolite, synthetic zeolite, silica, silica gel, alumina clay, diatomaceous earths, and combinations thereof.

11. The flue gas adsorbent of claim 9, comprising about 1 wt. % to about 15 wt. % reducing agent.

12. The flue gas adsorbent of claim 9, wherein the reducing agent is ascorbic acid.

13. The flue gas adsorbent of claim 9, wherein the reducing agent is selected from the group consisting of monosodium ascorbate, calcium diascorbate, monopotassium ascorbate, magnesium diascorbate, and combinations thereof.

14. The flue gas adsorbent of claim 9, wherein the adsorbent is a dry admixture of sorbent and reducing agent.

15. The flue gas adsorbent of claim 9, wherein the reducing agent is impregnated onto the sorbent.

16. The flue gas adsorbent of claim 9, further comprising a halogen precursor.

17. The flue gas adsorbent of claim 16, wherein the halogen precursor is selected from the group consisting of the calcium hypochlorite, calcium hypobromite, calcium hypoiodite, calcium chloride, calcium bromide, calcium iodide, magnesium chloride, magnesium bromide, magnesium iodide, sodium chloride, sodium bromide, sodium iodide, ammonium chloride, ammonium bromide, ammonium iodide, potassium tri-chloride, potassium tri-bromide, potassium tri-iodide, and combinations thereof.

18. The flue gas adsorbent of claim 16, wherein the halogen precursor is selected from the group consisting of calcium bromide (CaBr₂), ammonium bromide (NH₄Br), and combinations thereof.

19. The flue gas adsorbent of claim 16, wherein the halogen precursor is dry halogen precursor.

20. The flue gas adsorbent of claim 16, wherein the halogen precursor is impregnated onto the sorbent.
